(19) United States
(12) Patent Application Publication
(10) Pub. No.: US 2002/0069955 A1
(43) Pub. Date: Jun. 13, 2002

(54) Cardboard manufacturing process

(76) Inventor: Shang Jui Wang, Chung-Hua Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/733,341

(22) Filed: Dec. 7, 2000

(51) Int. Cl. B31F 1/20

(52) U.S. Cl. 156/210; 156/290

(57) ABSTRACT

A cardboard manufacturing process comprises the steps of forming a waterproof honeycomb structural member, forming a first member by adhering a top and a bottom layers of waterproof kraft paper on the honeycomb structural member, laminating a plurality of first members to form a second member, cutting and punching the second member to form a third member consisting of a top layer and a plurality of rib members extended downward from the top layer, adhering a waterproof frame member formed of kraft paper around either half periphery of the top layer, and adhering a plurality of waterproof groove members formed of kraft paper to the rib members. This cardboard has an enhanced structural strength.

### FIELD OF THE INVENTION

The present invention relates to a process for manufacturing a cardboard structure having improved structural strength.

### BACKGROUND OF THE INVENTION

Conventionally, a piece of cardboard has a corrugated structure for enhancing the structural strength. It is, however, still not strong enough in some applications. Further, its waterproof capability is poor. U.S. Pat. Nos. 5,076,176 and 5,129,329 both disclose similar cardboard structure. But these are unsatisfactory in the structural strength. Thus, it is desirable to provide an improved cardboard in order to overcome the above drawbacks of prior art.

### SUMMARY OF THE INVENTION

It is an object of the present invention to provide a cardboard manufacturing process comprising the steps of forming a waterproof honeycomb structural member, forming a first member by adhering a top and a bottom layers of waterproof kraft paper on the honeycomb structural member, laminating a plurality of first members to form a second member, cutting and punching the second member to form a third member consisting of a top layer and a plurality of rib members extended downward from the top layer, adhering a waterproof frame member formed of kraft paper around either half periphery of the top layer, and adhering a plurality of waterproof groove members formed of kraft paper to the rib members. This cardboard has an enhanced structural strength.

The above and other objects, features and advantages of the present invention will become apparent from the following detailed description taken with the accompanying drawings.

### BRIEF DESCRIPTION OF THE DRAWINGS

FIG. 1 is a perspective view of the honeycomb structural member of a cardboard according to the invention;

FIG. 2 is an exploded view of a first preferred embodiment of cardboard according to the invention;

FIG. 3 is a perspective view of the manufactured FIG. 2 cardboard;

FIG. 4 is another perspective view of the manufactured FIG. 2 cardboard;

FIG. 5 is an exploded view of a second preferred embodiment of cardboard according to the invention;

FIG. 6 is a perspective view of the manufactured FIG. 5 cardboard;

FIG. 7 is another perspective view of the manufactured FIG. 5 cardboard;

FIG. 8 is an exploded view of a third preferred embodiment of cardboard according to the invention;

FIG. 9 is a perspective view of the manufactured FIG. 8 cardboard; and

FIG. 10 is another perspective view of the manufactured FIG. 8 cardboard.

### DETAILED DESCRIPTION OF THE PREFERRED EMBODIMENTS

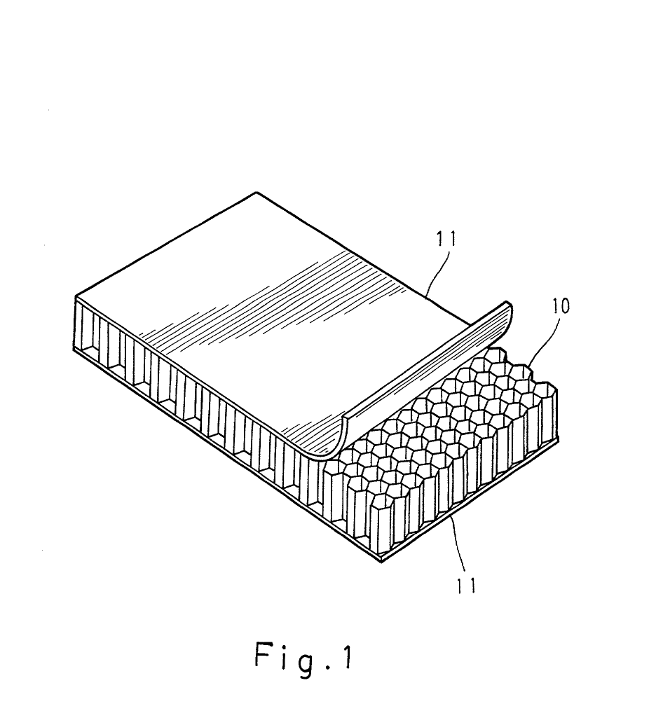

Referring to FIG. 1, there is shown the honeycomb structural member 10 of a cardboard manufactured in accordance with the invention. The raw material of honeycomb structural member 10 is pulp. The honeycomb structural member 10 is processed by a specially design honeycomb manufacturing machine. Then the half finished honeycomb structural member 10 is further extended and formed. Finally, a top and a bottom layers of kraft paper 11 are glued onto honeycomb structural member 10 to form a finished product. It is important to note that both honeycomb structural member 10 and the layers of kraft paper 11 are pre-processed to be waterproof.

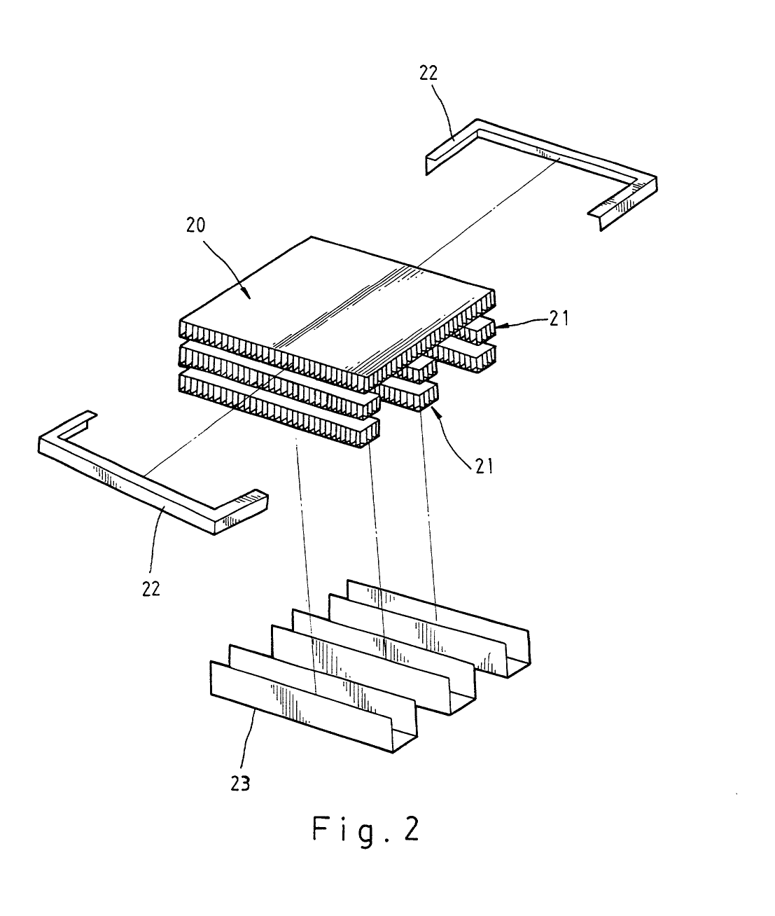

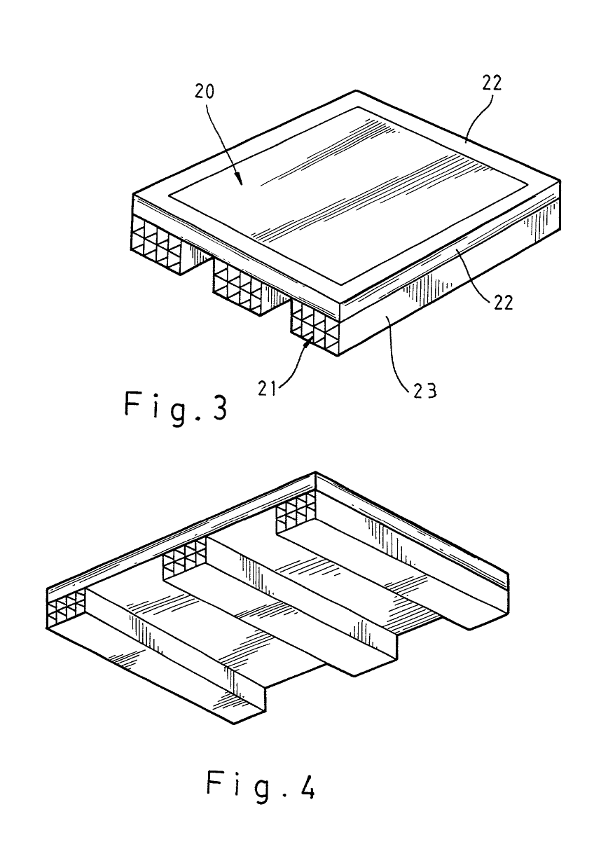

Referring to FIGS. 2 to 4, there is illustrated the process of manufacturing a piece of cardboard of a first preferred embodiment of the invention. A predetermined layers of honeycomb structural members 10 are further laminated, cut, and punched to form a member consisting of a top layer 20 and a plurality of rib members 21 extended downward from the top layer 20 as shown in FIG. 2. A waterproof frame member 22 formed of kraft paper is then secured around either half periphery of top layer 20. Finally, a plurality of waterproof groove members 23 formed of kraft paper shaped to rib members 21 are secured to the rib members 21. This forms a cardboard product having enhanced structural strength as shown in FIGS. 3 and 4.

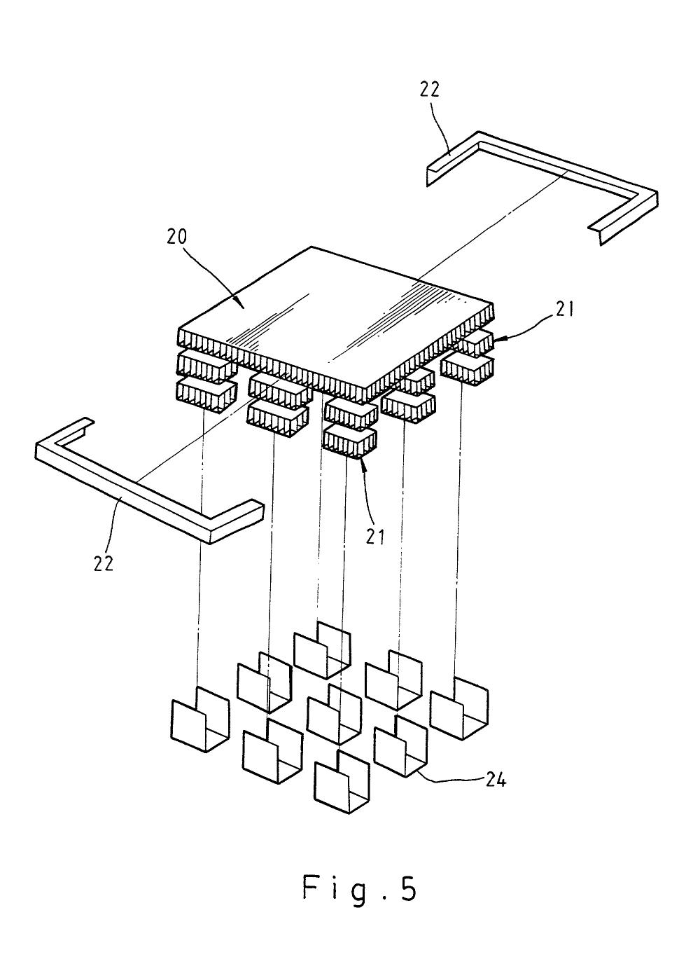

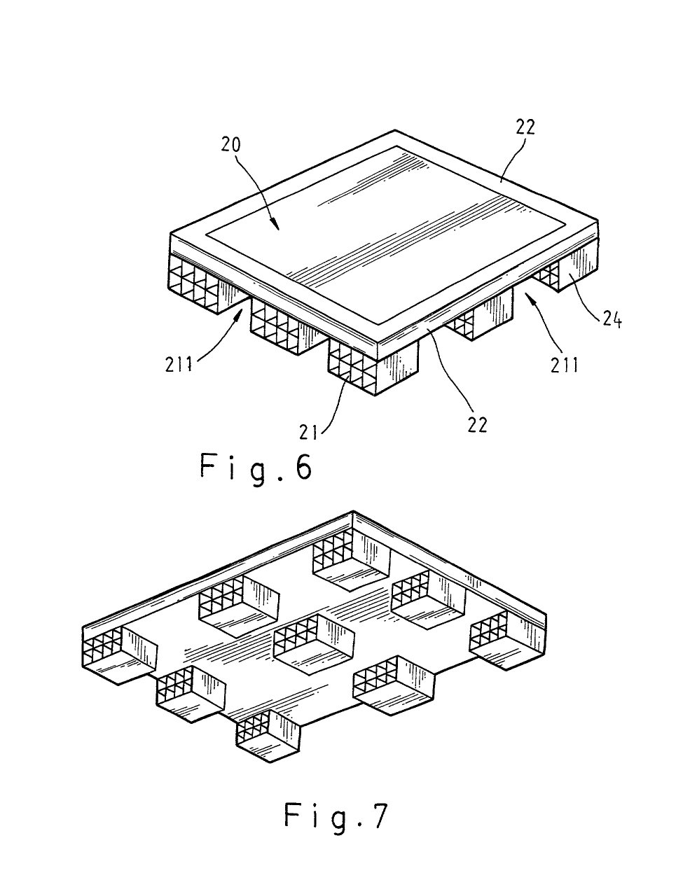

Referring to FIGS. 5 to 7, there is illustrated the process of manufacturing a piece of cardboard of a second preferred embodiment of the invention. The difference between this and the first embodiments is detailed below. Each of the plurality of groove members 23 is cut into a plurality of equally spaced apart sub-groove member 24. This may facilitate the forks of a forklift truck to insert into the gaps 211 between two sub-groove members 24 in operation.

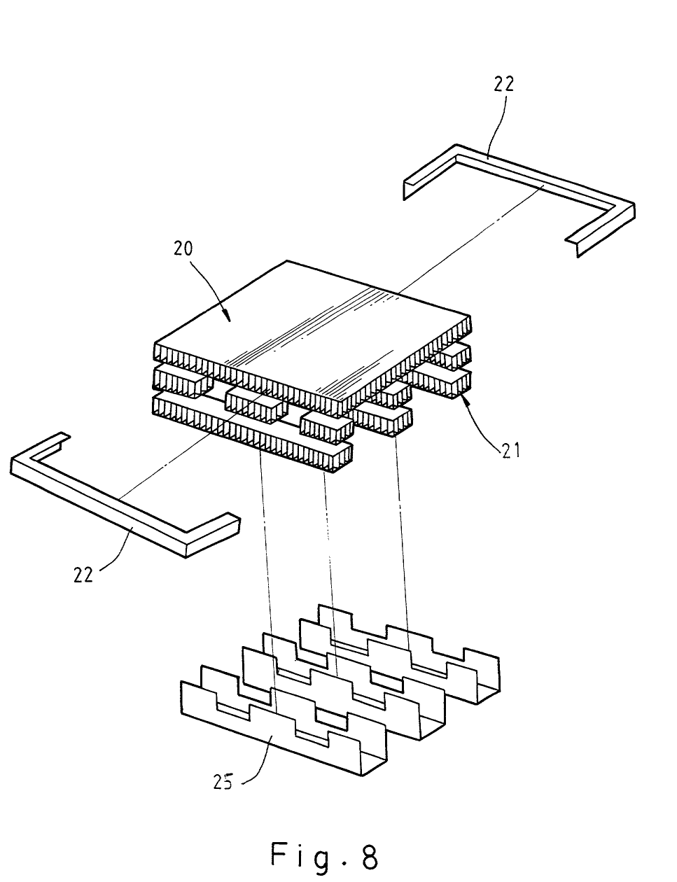

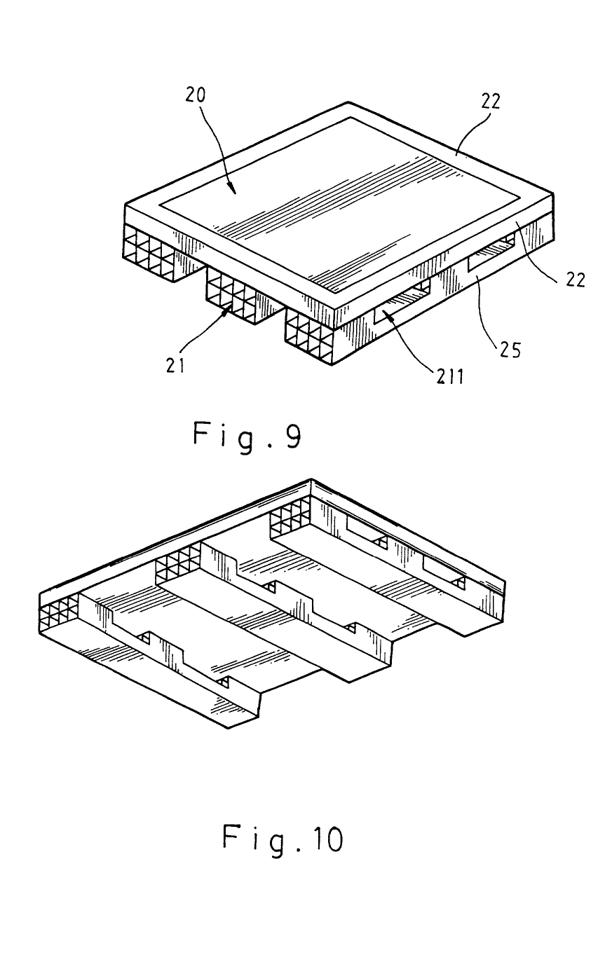

Referring to FIGS. 8 to 10, there is illustrated the process of manufacturing a piece of cardboard of a third preferred embodiment of the invention. The difference between this and the first embodiments is detailed below. Each groove member 23 is cut to form a groove member 25 having two toothed vertical sides. This also may facilitate the forks of a forklift truck to insert into the gaps 211 of groove members 25 in operation.

While the invention has been described by means of specific embodiments, numerous modifications and variations could be made thereto by those skilled in the art without departing from the scope and spirit of the invention set forth in the claims.

What is claimed is:

1. A cardboard manufacturing process comprising the steps of:
(a) forming a waterproof honeycomb structural member;
(b) forming a first member by adhering a top and a bottom layers of waterproof kraft paper on the honeycomb structural member;
(c) laminating a plurality of first members to form a second member;
(d) cutting and punching the second member to form a third member consisting of a top layer and a plurality of rib members extended downward from the top layer;
(e) adhering a waterproof frame member formed of kraft paper around either half periphery of the top layer; and
(f) adhering a plurality of waterproof groove members formed of kraft paper to the rib members.
